(19) United States
(12) Patent Application Publication
(10) Pub. No.: US 2022/0306807 A1
(43) Pub. Date: Sep. 29, 2022

(54) POLYIMIDE, FILM COMPOSITION, AND FILM PREPARED FROM THE SAME

(71) Applicant: INDUSTRIAL TECHNOLOGY RESEARCH INSTITUTE, Hsinchu (TW)

(72) Inventors: Yu-Yang SU, New Taipei City (TW); Yung-Lung TSENG, Zhubei City (TW); Chun-Wei SU, Zhubei City (TW)

(73) Assignee: INDUSTRIAL TECHNOLOGY RESEARCH INSTITUTE, Hsinchu (TW)

(21) Appl. No.: 17/564,997

(22) Filed: Dec. 29, 2021

Related U.S. Application Data
(60) Provisional application No. 63/166,343, filed on Mar. 26, 2021.

(30) Foreign Application Priority Data
Dec. 6, 2021 (TW) 110145399

(51) Int. Cl. C08G 73/10; C09D 179/08

(52) U.S. Cl. CPC C08G 73/1071; C08G 73/1042; C08G 73/1039; C08G 73/1032; C08G 73/1046; C09D 179/08

(57) ABSTRACT

A polyimide, a film composition, and film prepared from the same are provided. The polyimide is a product of a reactant (a) and a reactant (b). The reactant (a) consists of a first dianhydride and a second dianhydride. The first dianhydride has a structure represented by Formula (I) and the second dianhydride has a structure represented by Formula (II)

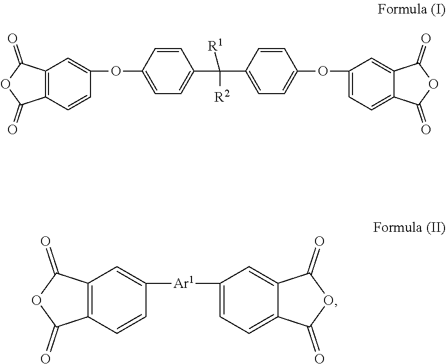

wherein R¹, R² and Ar¹ are as defined in specification. The reactant (b) includes a first diamine, wherein the first diamine is

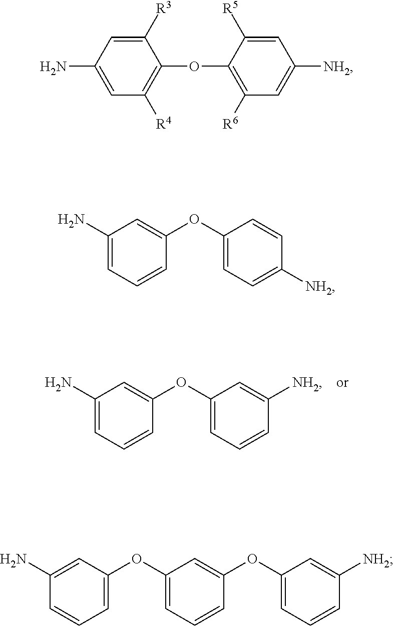

and R³, R⁴, R⁵, or R⁶ are as defined in specification.

### CROSS REFERENCE TO RELATED APPLICATIONS

This application claims the benefit of U.S. Provisional Application No. 63/166,343, filed on Mar. 26, 2021, which is hereby incorporated herein by reference. The application is based on, and claims priority from, Taiwan Application Serial Number 110145399, filed on Dec. 6, 2021, the disclosure of which is hereby incorporated by reference herein in its entirety.

### TECHNICAL FIELD

The disclosure relates to a polyimide, a film composition, and a film prepared from the same.

### BACKGROUND

Due to the excellent thermal stability and insulation properties of polyimide, it is often used as an insulating material and in the production of special industrial plastics. In addition, polyimide is widely used in flexible printed circuit boards (FPCs). With the development of mobile and personalized communication devices in recent years, demand for lightweight and thin, flexible printed circuit boards has increased sharply. With the increased functional integration of terminal application products, soft board technology must also be enhanced to meet certain increased requirements, such as high resolution, high response speed, and a large storage capacity. Therefore, the developmental trend in the design of flexible boards has been towards high frequency, high speed, and functionalization. Flexible boards used in high-frequency applications has become a trend in flexible board technology. The main focus of flexible boards used in high-frequency applications is that the substrate should exhibit a low dielectric coefficient and a low dielectric loss factor in order to match the enhancement and integration of the functions of mobile communication electronic devices. With an anticipated increase of the operation frequency used in future 5G mobile communications, the development of multifunctional flexible boards capable of operating at high speeds and used in high-frequency applications is becoming more and more important. The water absorption rate of conventional polyimide resin is relatively high, and thus the characteristics of polyimide are easily affected by the operation environment of electronic equipment. In an environment marked by high humidity, the moisture absorption of the polyimide resin layer may increase the dielectric loss factor (Df) of polyimide, exacerbating transmission loss. Therefore, a liquid-crystal polymer (LCP) with superior dielectric characteristics and water absorption rate is used in the portion that requires low transmission loss. Although the dielectric loss factor (Df) of liquid-crystal polymer is not affected by humidity, the liquid-crystal polymer still has some disadvantages, such as low adhesion to metal foil (such as copper foil), low thermal tolerance, and poor operability.

Therefore, researchers studying the high-frequency dielectric properties and low water absorption rate of polyimide resin have focused their technical development efforts to aid material manufacturers and flexible board suppliers.

### SUMMARY

The disclosure provides a polyimide, wherein the polyimide is a reaction product of a reactant (a) and a reactant (b), wherein the reactant (a) is a first dianhydride and a second dianhydride, the first dianhydride having a structure represented by Formula (I), and the second dianhydride having a structure represented by Formula (II)

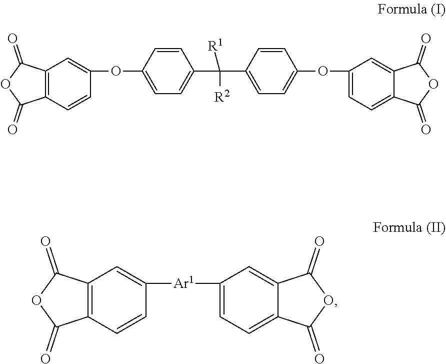

wherein R¹ and R² are independently hydrogen, fluorine, methyl group, ethyl group, propyl group, fluoromethyl group, fluoroethyl group, or fluoropropyl group; Ar¹ is

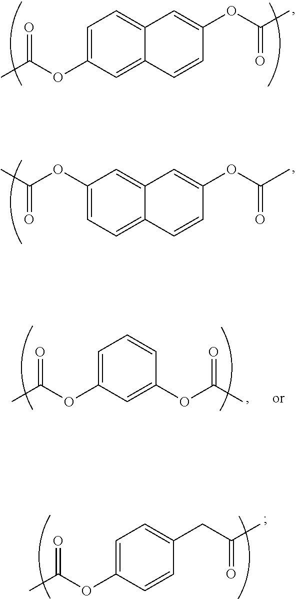

and the reactant (b) includes a first diamine, wherein the first diamine is

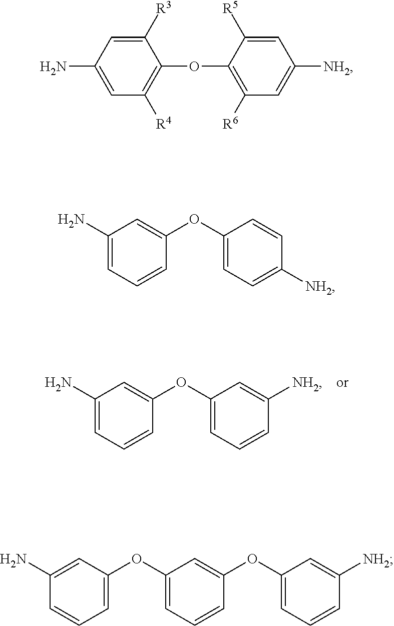

and R³, R⁴, R⁵, or R⁶ are independently hydrogen, fluorine, methyl group, ethyl group, propyl group, fluoromethyl group, fluoroethyl group, or fluoropropyl group.

According to embodiments of the disclosure, the disclosure also provides a film composition. The film composition can include the polyimide of the disclosure, and a solvent, wherein the solid content of the film composition can be 5 wt % to 30 wt %.

According to embodiments of the disclosure, the disclosure also provides a film. The film can include the cured product of the aforementioned film composition.

A detailed description is given in the following embodiments.

### DETAILED DESCRIPTION

The polyimide, film composition, and film prepared from the same of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art. As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

The disclosure provides a polyimide, a film composition employing the polyimide, and a film prepared from the film composition. The polyimide is prepared by reacting two specific dianhydride (such as aryl-moiety-containing dianhydride) with a specific diamine (such as aryl-moiety-containing diamine) at a specific molar ratio. The film prepared from the film composition including the polyimide exhibits low dielectric coefficient (Dk) and low dielectric loss factor (Df) at high frequency (such as larger than 10 GHz) and has a low water absorption rate. Therefore, the film prepared from the film composition of the disclosure can have stable dielectric characteristics. According to embodiments of the disclosure, the film composition can be further coated on a metal foil substrate, and still exhibits superior adhesive strength, thermal tolerance and chemical resistance. According to embodiments of the disclosure, since the film composition employs specific solvent to dissolve or disperse the polyimide of the disclosure, the polyimide exhibits increased polymerization degree and the film prepared from the film composition has a relatively uniform thickness and a relatively high chemical resistance. In addition, the thickness of the film composition can be modified by adjusting the solid content of the film composition.

The disclosure provides a polyimide, a film composition employing the polyimide, and a film prepared from the film composition. The polyimide is prepared by reacting two specific dianhydride (such as aryl-moiety-containing dianhydride) with a specific diamine (such as aryl-moiety-containing diamine) at a specific molar ratio. The film prepared from the film composition including the polyimide exhibits low dielectric coefficient (Dk) and low dielectric loss factor (Df) at high frequency (such as larger than 10 GHz) and has a low water absorption rate. Therefore, the film prepared from the film composition of the disclosure can have stable dielectric characteristics. According to embodiments of the disclosure, the film composition can be further coated on a metal foil substrate, and still exhibits superior adhesive strength, thermal tolerance and chemical resistance. According to embodiments of the disclosure, since the film composition employs specific solvent to dissolve or disperse the polyimide of the disclosure, the polyimide exhibits increased polymerization degree and the film prepared from the film composition has a relatively uniform thickness and a relatively high chemical resistance. In addition, the thickness of the film composition can be adjusted by varying the solid content of the film composition.

According to embodiments of the disclosure, the polyimide of the disclosure can be a reaction product of a reactant (a) and a reactant (b) via a reaction (such as polymerization). The reactant (a) can be at least one dianhydride (such as aryl-moiety-containing dianhydride). According to embodiments of the disclosure, the reactant (a) can consists of a first dianhydride and a second dianhydride. According to embodiments of the disclosure, the first dianhydride can have a structure represented by Formula (I), and the second dianhydride can have a structure represented by Formula (II)

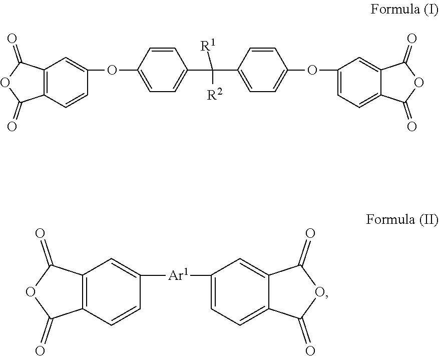

wherein R¹ and R² are independently hydrogen, fluorine, methyl group, ethyl group, propyl group, fluoromethyl group, fluoroethyl group, or fluoropropyl group; Ar¹ is

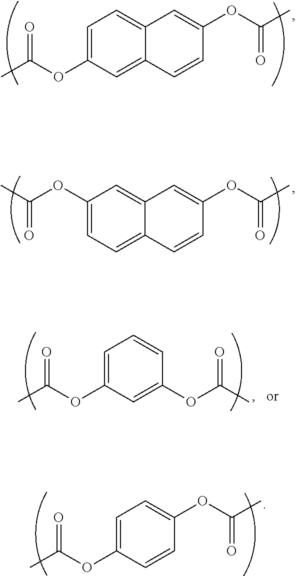

According to embodiments of the disclosure, the fluoromethyl group of the disclosure can be monofluoromethyl group, difluoromethyl group, or perfluoromethyl group; fluoroethyl group can be monofluoroethyl group, difluoroethyl group, trifluoroethyl group, tetrafluoroethyl group, or perfluoroethyl group; and fluoropropyl group can be monofluoropropyl group, difluoropropyl group, trifluoropropyl group, tetrafluoropropyl group, pentafluoropropyl group, hexfluoropropyl group, or perfluoropropyl group. According to embodiments of the disclosure, the propyl group of the disclosure can be n-propyl group, or isopropyl group, and fluoropropyl group can be fluoro-n-propyl group, or fluoroisopropyl group.

According to embodiments of the disclosure, the first dianhydride can be

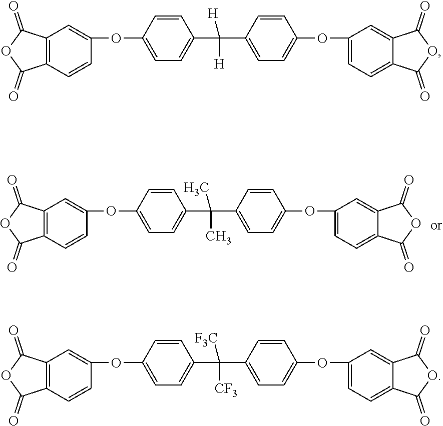 [SMILES: O=C1OC(=O)c2cc(Oc3ccc(Cc4ccc(Oc5ccc6c(c5)C(=O)OC6=O)cc4)cc3)ccc21 ; CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(Oc3ccc(C(c4ccc(Oc5ccc6c(c5)C(=O)OC6=O)cc4)(C(F)(F)F)C(F)(F)F)cc3)ccc21]

According to embodiments of the disclosure, the first dianhydride can be 2,2-bis[4-(3,4-dicarboxyphenoxy)phenyl]propanedianhydride (BPADA).

According to embodiments of the disclosure, the second dianhydride can be

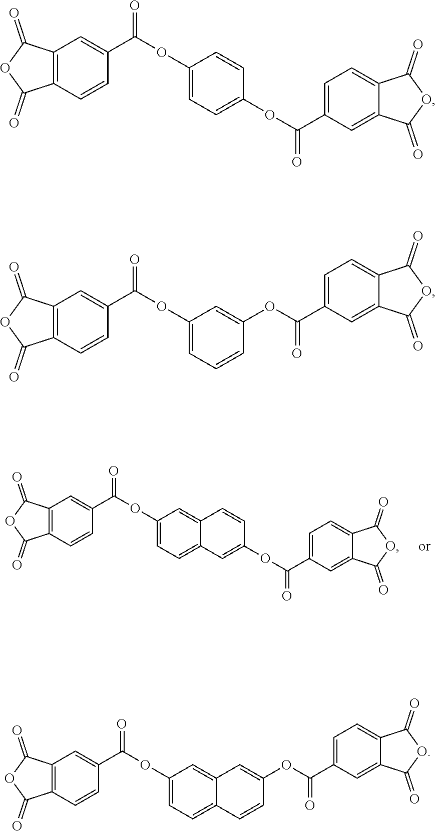 [SMILES: O=C(Oc1ccc(OC(=O)c2ccc3c(c2)C(=O)OC3=O)cc1)c1ccc2c(c1)C(=O)OC2=O ; O=C(Oc1cccc(OC(=O)c2ccc3c(c2)C(=O)OC3=O)c1)c1ccc2c(c1)C(=O)OC2=O ; O=C(Oc1ccc2cc(OC(=O)c3ccc4c(c3)C(=O)OC4=O)ccc2c1)c1ccc2c(c1)C(=O)OC2=O ; O=C(Oc1ccc2ccc(OC(=O)c3ccc4c(c3)C(=O)OC4=O)cc2c1)c1ccc2c(c1)C(=O)OC2=O]

According to embodiments of the disclosure, the second dianhydride can be p-phenylenebis (trimellitate anhydride) (TAHQ), or 2,6-dihydroxynaphthalene bis(trimellitate anhydride) (2,6-TANA).

According to embodiments of the disclosure, the molar ratio of the first dianhydride to the second dianhydride can be 3:7 to 8:2, such as about 4:6, 5:5, 6:4, 7:3, or 7.5:2.5. When the molar ratio of the first dianhydride to the second dianhydride is too high or too low, the film prepared from the film composition including the polyimide is apt to cause directional fragmentation, or the obtained film (cured product) has inferior dielectric loss factor properties (>0.005 (@10 GHZ)) and exhibits relatively high water absorption property (>1.0%).

According to embodiments of the disclosure, the reactant (b) can be at least one of diamine (such as aryl-moiety-containing diamine). According to embodiments of the disclosure, the reactant (b) includes a first diamine. According to embodiments of the disclosure, the first diamine can be

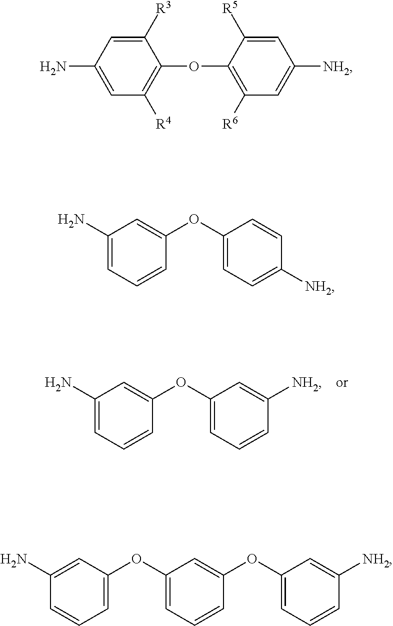

wherein R³, R⁴, R⁵, or R⁶ are independently hydrogen, fluorine, methyl group, ethyl group, propyl group, fluoromethyl group, fluoroethyl group, or fluoropropyl group.

According to embodiments of the disclosure, the reactant (b) is the first diamine. According to embodiments of the disclosure, the first diamine can be

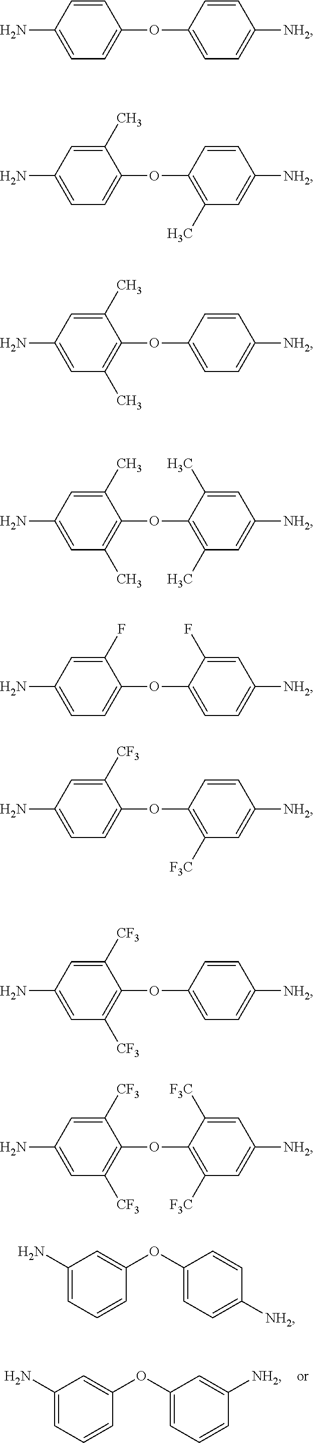

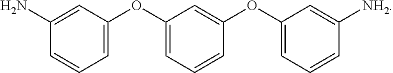 [SMILES: Nc1cccc(Oc2cccc(Oc3cccc(N)c3)c2)c1]

According to embodiments of the disclosure, the first diamine can be 4,4′-Oxybis[3-(trifluoroMethyl)aniline] (TMDA), 4,4′-oxydianiline (ODA), or 1,3-bis(3-aminophenoxy) benzene (APB-N).

According to embodiments of the disclosure, the molar ratio of the reactant (a) and the reactant (b) (which undergo the reaction (such as polymerization) to form the polyimide can be substantially in a range of about 0.95:1.05 to 1.05:0.95, such as near to about 1:1.

According to embodiments of the disclosure, besides the first diamine, the reactant (b) can further include a second diamine, wherein the second diamine is

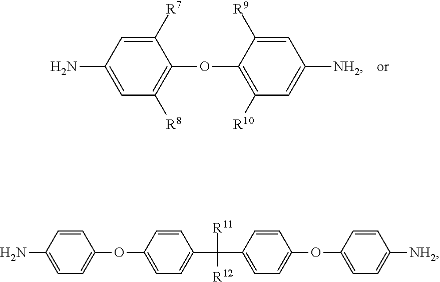

wherein R⁷, R⁸, R⁹, R¹⁰, R¹¹, or R¹² are independently hydrogen, fluorine, methyl group, ethyl group, propyl group, fluoromethyl group, fluoroethyl group, or fluoropropyl group. In addition, the first diamine is different from the second diamine.

According to embodiments of the disclosure, the second diamine can be

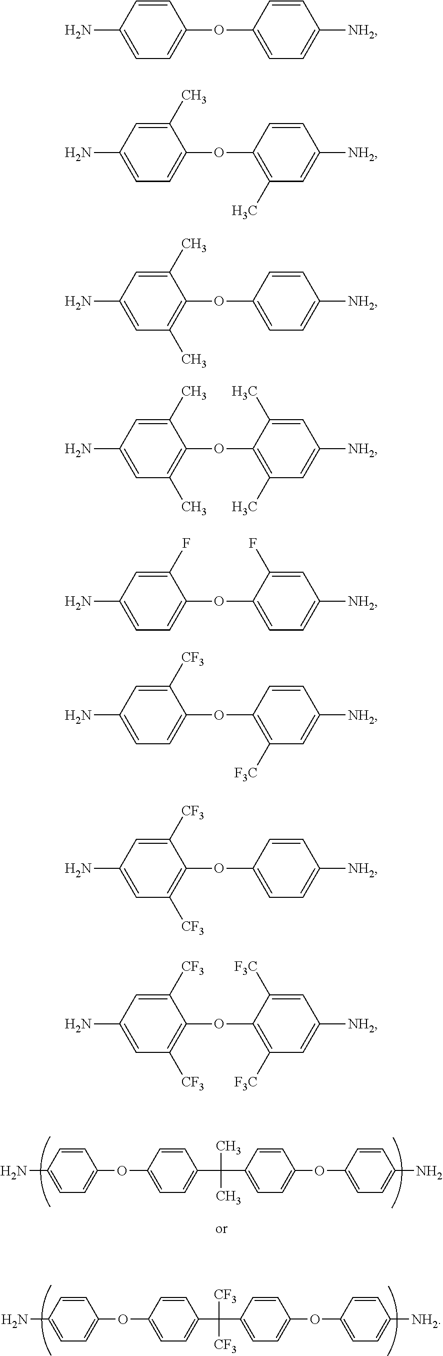

According to embodiments of the disclosure, the second diamine can be 2,2-bis[4-(4-aminophenoxy)phenyl] propane (BAPP), 4,4′-oxydianiline (ODA), or 2,2-bis[4-(4-aminophenoxy)phenyl]hexafluoropropane (HFBAPP). According to embodiments of the disclosure, when the first diamine is 4,4′-oxydianiline (ODA), the second diamine is 2,2-bis[4-(4-aminophenoxy)phenyl] propane (BAPP), or 2,2-bis[4-(4-aminophenoxy)phenyl]hexafluoropropane (HFBAPP).

According to embodiments of the disclosure, the reactant (b) can consist of the first diamine and the second diamine. According to embodiments of the disclosure, the molar ratio of the first diamine to the second diamine can be 1:9 to 9:1, such as 2:8, 3:7, 4:6, 5:5, 6:4, 7:3, or 8:2.

According to embodiments of the disclosure, the reactant (b) can further include a third diamine, wherein the third diamine can be

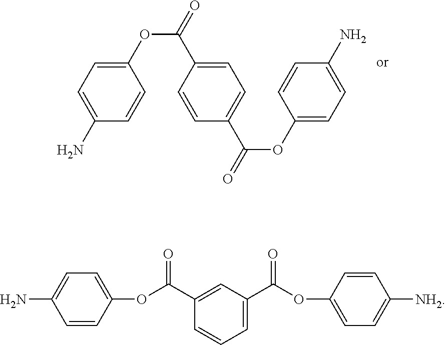 [SMILES: Nc1ccc(OC(=O)c2ccc(C(=O)Oc3ccc(N)cc3)cc2)cc1 ; Nc1ccc(OC(=O)c2cccc(C(=O)Oc3ccc(N)cc3)c2)cc1]

According to embodiments of the disclosure, the third diamine can be bis(4-aminophenyl) terephthalate (BPTP).

According to embodiments of the disclosure, the reactant (b) can consist of the first diamine, the second diamine, and the third diamine. According to embodiments of the disclosure, the molar ratio of the first diamine to the second diamine can be 1:9 to 9:1(such as: 2:8, 3:7, 4:6, 5:5, 6:4, 7:3, or 8:2), and the ratio of the mole of the third diamine to the total mole of the first diamine and the second diamine is about 1:99 to 1:9 (such as: about 2:98, 3:97, 4:96, 5:95, 6:94, 7:93, 8:92, or 9:91).

According to embodiments of the disclosure, the weight average molecular weight (Mw) of the polyimide of the disclosure can be about 5,000 g/mol to 3,000,000 g/mol, such as about 8,000 g/mol to 2,500,000 g/mol, 10,000 g/mol to 2,300,000 g/mol, 15,000 g/mol to 2,000,000 g/mol, 10,000 g/mol to 1,000,000 g/mol, 10,000 g/mol to 500,000 g/mol, or 10,000 g/mol to 300,000 g/mol. The weight average molecular weight (Mw) of the polyimide of the disclosure can be determined by gel permeation chromatography (GPC) based on a polystyrene calibration curve.

According to embodiments of the disclosure, the polyimide of the disclosure can be prepared by following steps. First, the reactant (a) and the reactant (b) was added into a reaction bottle, and then dissolved in a solvent, obtaining a solution. The solid content of the solution can be about 5 wt % to 45 wt % (such as about 6 wt %, 8 wt %, 10 wt %, 12 wt %, 14 wt %, 15 wt %, 18 wt %, 20 wt %, 21 wt %, 22 wt %, 25 wt %, 27 wt %, 29 wt %, 30 wt %, 32 wt %, 34 wt %, 35 wt %, 38 wt %, 40 wt %, 42 wt %, or 44 wt %). The reactant (a) and reactant (b) are defined as above. According to embodiments of the disclosure, in order to keep the obtained polyimide soluble in the used solvent without replacing it with other solvent, the solvent used in the preparation of the polyimide can include N-methylpyrrolidinone, dimethylacetamide, γ-butyrolactone, p-xylene or a combination thereof. According to embodiments of the disclosure, the solvent can be N-methylpyrrolidinone, dimethylacetamide, or γ-butyrolactone. According to embodiments of the disclosure, the molar ratio of the reactant (a) to the reactant (b) can be about 1.1:0.9 to 0.9:1.1, such as about 1:1. According to embodiments of the disclosure, in order to accelerate the polymerization for the formation of the polyimide, a catalyst can be optionally added into the solution, wherein the amount of the catalyst can be 0.01 wt % to 1 wt % (such as about 0.02 wt %, 0.05 wt %, 0.1 wt %, 0.2 wt %, 0.3 wt %, 0.5 wt %, 0.7 wt %, or 0.9 wt %), based on the total weight of the reactant (a) and the reactant (b). Next, the solution is reacted at 180° C.-250° C. for 4-12 hours, obtaining the solution (polyimide solution) including the polyimide of the disclosure. When the solvent is N-methylpyrrolidinone, dimethylacetamide, p-xylene, γ-butyrolactone, or a combination thereof and the molar ratio of the reactant (a) to the reactant (b) is about 1, the polyimide can be dissolved in the solvent without purification. Therefore, the obtained polyimide solution can directly serve as the film composition of the disclosure. According to embodiments of the disclosure, the aforementioned catalyst can be any catalyst used for imidization, such as tertiary amine. For example, the tertiary amine can include triethylenediamine (DABCO), N,N-dimethylcyclohexylamine, 1,2-dimethylimidazole, trimethylamine, triethylamine, tripropylamine, tributylamine, triethanolamine, N,N-dimethylethanolamine, N,N-diethylethanolamine, triethylenediamine, N-methylpyrrolidine, N-ethylpyrrolidine, N-methyl piperidine, N-ethyl piperidine, imidazole, pyridine, methyl pyridine, dimethyl pyridine, quinoline or isoquinoline.

According to embodiments of the disclosure, the film composition of the disclosure can include the polyimide of the disclosure and a solvent. In addition, According to some embodiments of the disclosure, the film composition of the disclosure can consist of the polyimide of the disclosure and a solvent. The solvent can be N-methylpyrrolidinone, dimethylacetamide, γ-butyrolactone, p-xylene or a combination thereof, and the solid content of the film composition can be 5 wt % to 45 wt % (such as about 6 wt %, 8 wt %, 10 wt %, 12 wt %, 14 wt %, 15 wt %, 18wt %, 20 wt %, 21 wt %, 22 wt %, 25 wt %, 27 wt %, 29 wt %, 30 wt %, 32 wt %, 34 wt %, 35 wt %, 38 wt %, 40 wt %, 42 wt %, or 44 wt %). According to embodiments of the disclosure, the thickness of the film composition is directly proportional to the solid content of the film composition. Namely, the thickness of the film prepared from the film composition can be adjusted by the solid content of the film composition.

According to embodiments of the disclosure, the polyimide solution prepared by reacting the reactant (a) with the reactant (b) to undergo a reaction (such as imidization) can be directly used as the film composition of the disclosure. According to embodiments of the disclosure, the film composition of the disclosure consists substantially of the polyimide of the disclosure and a solvent. Namely, the polyimide and the solvent are main ingredients of the film composition, and the total weight of the polyimide and the solvent of the film composition are about 90 wt % to 99.99 wt % (such as 93 wt %, 95 wt %, 98 wt %, 99 wt %, or 99.5 wt %). In addition, apart from the main ingredients, the other ingredients of the film composition are defined as the minor ingredients. According to embodiments of the disclosure, the minor ingredients can be the catalyst for preparing the polyimide, the residual reactant (a) and/or reactant (b) which is used to prepare the polyimide, additive, or a combination thereof. The total weight of the minor ingredients can be about 0.01 wt % to 10 wt %, based on the total weight of the film composition. According to embodiments of the disclosure, the additive can be known by those skilled in the art additive, such as filler, flame retardant, viscosity modifier, thixotropic agent, defoamer, leveling agent, surface treatment agent, stabilizer, antioxidant, or a combination thereof. According to other embodiments of the disclosure, the film composition of the disclosure can consist of the main ingredients and the minor ingredients.

According to embodiments of the disclosure, the disclosure also provides a film, which is the cured product of the film composition of the disclosure. According to embodiments of the disclosure, the film of the disclosure can be prepared by the following steps. First, a coating of the film composition of the disclosure can be formed on a substrate via a coating process. According to embodiments of the disclosure, the coating process can be screen printing, spin coating, bar coating, blade coating, roller coating, dip coating, spray coating, or brush coating. Next, the coating is subjected to a baking process to form a film. The temperature of the baking process can be about 50° C.-350° C., or less than 290° C. (such as 70° C.-260° C.), and process time period can be 30 minutes to 8 hours. According to embodiments of the disclosure, the baking process can be multistage baking process.

Below, exemplary embodiments will be described in detail so as to be easily realized by a person having ordinary knowledge in the art. The inventive concept may be embodied in various forms without being limited to the exemplary embodiments set forth herein.

### EXAMPLE

Table 1 lists the reagents involved in the Examples and Comparative Examples of the disclosure.

TABLE 1

| abbrevia- | | |
|---|---|---|
| tion | name | structure |
| BPADA | 2,2-bis[4-(3,4- dicarboxyphenoxy)phenyl]propanedian- hydride | 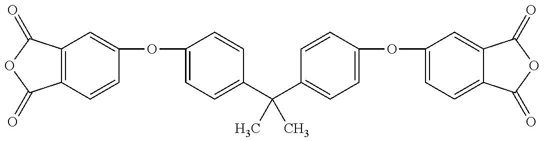 [SMILES: CC(C)(c1ccc(Oc2ccc3c(c2)C(=O)OC3=O)cc1)c1ccc(Oc2ccc3c(c2)C(=O)OC3=O)cc1] |
| TAHQ | p-phenylenebis(trimellitate anhydride) | 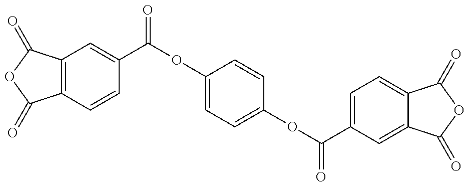 [SMILES: O=C(Oc1ccc(OC(=O)c2ccc3c(c2)C(=O)OC3=O)cc1)c1ccc2c(c1)C(=O)OC2=O] |
| 2,6-TANA | 2,6-dihydroxynaphthalene- bis(trimellitate anhydride) | 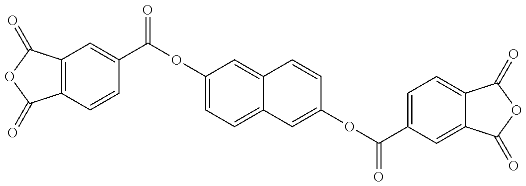 [SMILES: O=C(Oc1ccc2cc(OC(=O)c3ccc4c(c3)C(=O)OC4=O)ccc2c1)c1ccc2c(c1)C(=O)OC2=O] |
| ODA | 4,4′-oxydianiline | 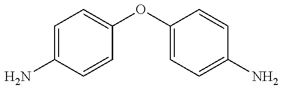 [SMILES: Nc1ccc(Oc2ccc(N)cc2)cc1] |
| BPTP | bis(4-aminophenyl)terephthalate | 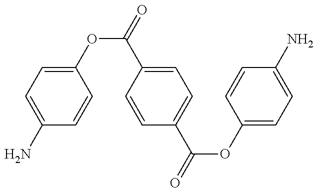 [SMILES: Nc1ccc(OC(=O)c2ccc(C(=O)Oc3ccc(N)cc3)cc2)cc1] |
| APB-N | 1,3-bis(3-aminophenoxy)benzene | 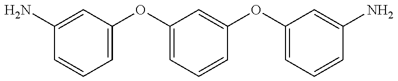 [SMILES: Nc1cccc(Oc2cccc(Oc3cccc(N)c3)c2)c1] |
| TMDA | 4,4′-Oxybis[3- (trifluoroMethyl)aniline]) | 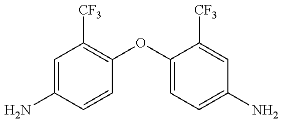 [SMILES: Nc1ccc(Oc2ccc(N)cc2C(F)(F)F)c(C(F)(F)F)c1] |
| BAPP | 2,2-bis[4-(4-aminophenoxy)phenyl] propane) | 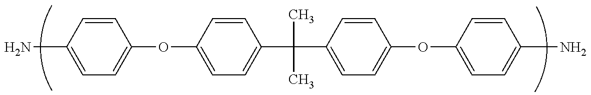 |
| HFBAPP | 2,2-bis[4-(4- aminophenoxy)phenyl]hexa- fluoropropane) | 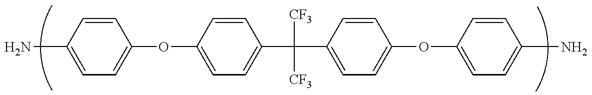 |
| abbrevia- | | |
| tion | name | use |
| | isoquinoline | catalyst |
| NMP | N-methylpyrrolidinone | solvent |
| DMAC | dimethylacetamide | solvent |
| GBL | γ-butyrolactone | solvent |

### Preparation of Polyimide

### Example 1

### 2,2-bis[4-(3,4-dicarboxyphenoxy)phenyl]propanedianhydride (BPADA)

(60 parts by mole), 2,6-dihydroxynaphthalene bis(trimellitate anhydride) (2,6-TANA) (40 parts by mole), and 1,3-bis(3-aminophenoxy) benzene (APB-N) (100 parts by mole) were added into a reaction bottle and dissolved in N-methylpyrrolidinone (NMP), obtaining a solution (with a solid content of about 25 wt %). Next, isoquinoline (served as catalyst, with an amount of about 0.3 wt %, based on the total weight of BPADA, 2,6-TANA, and APB-N) was added into the reaction bottle. The result was allowed to react at 200° C.-220° C. for 6 hours, obtaining Film composition (1) employing the polyimide of the disclosure, wherein Film composition (1) had a solid content about 25 wt %, and the solvent was N-methylpyrrolidinone.

Next, Film composition (1) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, and the results are shown in Table 2.

The water absorption rate of the disclosure is determined by the following equation: water absorption rate=(W1−W0)/W0×100%, wherein W0 refers to the weight of the cured product after baking in an oven at 110° C. for 1 hour and cooling down to room temperature; and W1 refers to the weight of the cured product after immersing the cured product in water at 30° C. for 24 hours. The dielectric coefficient (Dk) and the dielectric loss factor (Df) is measured by microwave dielectrometer (commercially available from AET) at 10 GHz.

### Comparative Example 1

### 2,2-bis[4-(3,4-dicarboxyphenoxy)phenyl]propanedianhydride (BPADA)

(10 parts by mole), 2,6-dihydroxynaphthalene bis(trimellitate anhydride) (2,6-TANA) (90 parts by mole), and 4,4′-oxydianiline (ODA) (100 parts by mole) were added into a reaction bottle and dissolved in N-methylpyrrolidinone (NMP), obtaining a solution (with a solid content of about 25 wt %). Next, isoquinoline (served as catalyst, with an amount of about 0.3 wt %, based on the total weight of BPADA, 2,6-TANA, and ODA) was added into the reaction bottle. The result was allowed to react at 200° C.-220° C. for 6 hours, obtaining Film composition (2) employing the polyimide of the disclosure, wherein Film composition (2) had a solid content about 25 wt %, and the solvent was N-methylpyrrolidinone.

Next, Film composition (2) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, and it was observed that no film could be prepared from the film composition or the film prepared from the film composition was easily broken.

### Comparative Example 2

Comparative Example 2 was performed in the same manner as in Example 1, except that 2,2-bis[4-(3,4-dicarboxyphenoxy)phenyl]propanedianhydride (BPADA) was 10 parts by mole, and 2,6-dihydroxynaphthalene bis(trimellitate anhydride) (2,6-TANA) was 90 parts by mole, obtaining Film composition (3) employing the polyimide of the disclosure, wherein Film composition (3) had a solid content about 25 wt %, and the solvent was N-methylpyrrolidinone.

Next, Film composition (3) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, and it was observed that no film could be prepared from the film composition or the film prepared from the film composition was easily broken.

### Example 2

Example 2 was performed in the same manner as in Example 1, except that 1,3-bis(3-aminophenoxy) benzene (APB-N) was replaced with 4,4′ -oxydianiline (ODA), obtaining Film composition (4) employing the polyimide of the disclosure, wherein Film composition (4) had a solid content about 25 wt %, and the solvent was N-methylpyrrolidinone.

Next, Film composition (4) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, and the results are shown in Table 2.

TABLE 2

| | | | | | | | water |
|---|---|---|---|---|---|---|---|
| | BPADA | 2,6-TANA | APB-N | ODA | | | absorption |
| | (parts | (parts | (parts | (parts | Dk@ | Df@ | rate |
| | by mole) | by mole) | by mole) | by mole) | 10 GHz | 10 GHz | (%) |
| Example 1 | 60 | 40 | 100 | — | 2.671 | 0.0032 | 0.32 |
| Comparative | 10 | 90 | — | 100 | No film formed | | |
| Example 1 | | | | | | | |
| Comparative | 10 | 90 | 100 | — | No film formed | | |
| Example 2 | | | | | | | |
| Example 2 | 60 | 40 | — | 100 | 2.762 | 0.0044 | 0.55 |

As shown in Table 2, since the molar ratio of BPADA to 2,6-TANA (i.e. the dianhydride used for preparing polyimide of Film composition (2) of Comparative Example 1) was 1:9, Film composition (2) of Comparative Example 1 was unable to be used for film forming. As shown in Examples 1 and 2, when preparing the polyimide at a specific molar ratio of BPADA and 2,6-TANA to APB-N (or ODA), the water absorption rate of the cured product of the obtained film composition can be reduced (for example the water absorption rate can be less than 0.55%, even less than 0.35%), on the premise that the dielectric coefficient (Dk) and the dielectric loss factor are not increased.

### Example 3

### 2,2-bis[4-(3,4-dicarboxyphenoxy)phenyl]propanedianhydride (BPADA)

(60 parts by mole), 2,6-dihydroxynaphthalene bis(trimellitate anhydride) (2,6-TANA) (40 parts by mole), 4,4′-oxydianiline (ODA) (40 parts by mole) and 1,3-bis(3-aminophenoxy) benzene (APB-N) (60 parts by mole) were added into a reaction bottle and dissolved in dimethylacetamide (DMAC), obtaining a solution (with a solid content of about 25 wt %). Next, isoquinoline (served as catalyst, with an amount of about 0.3 wt %, based on the total weight of BPADA, 2,6-TANA, ODA and APB-N) was added into the reaction bottle. The result was allowed to react at 200° C.-220° C. for 6 hours, obtaining Film composition (5) employing the polyimide of the disclosure, wherein Film composition (5) had a solid content about 25 wt %, and the solvent was dimethylacetamide.

Next, Film composition (5) was coated on a substrate (such as glass substrate) by blade coating, forming a coating (with a thickness of about 18 μm). Next, after baking the coating at 80° C. for 30 minutes, the solvent (DMAC) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Example 4

Example 4 was performed in the same manner as in Example 3, except that 2,2-bis[4-(3,4-dicarboxyphenoxy)phenyl]propanedianhydride (BPADA) was increased from 60 parts by mole to 70 parts by mole, and 2,6-dihydroxynaphthalene bis(trimellitate anhydride) (2,6-TANA) was reduced from 40 parts by mole to 30 parts by mole, obtaining Film composition (6) employing the polyimide of the disclosure, wherein Film composition (6) had a solid content about 25 wt %, and the solvent was 1-methyl-2-pyrrolidinone.

Next, Film composition (6) was coated on a substrate (such as glass substrate) by blade coating, forming a coating (with a thickness of about 18 μm). Next, after baking the coating at 80° C. for 30 minutes, the solvent (DMAC) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Example 5

### 2,2-bis[4-(3,4-dicarboxyphenoxy)phenyl]propanedianhydride (BPADA)

(60 parts by mole), 2,6-dihydroxynaphthalene bis(trimellitate anhydride) (2,6-TANA) (40 parts by mole), 4,4′-oxydianiline (ODA) (40 parts by mole), and 2,2-bis[4-(4-aminophenoxy)phenyl]hexafluoropropane (HFBAPP) (60 parts by mole) were added into a reaction bottle and dissolved in dimethylacetamide (DMAC), obtaining a solution (with a solid content of about 25 wt %). Next, isoquinoline (served as catalyst, with an amount of about 0.3 wt %, based on the total weight of BPADA, 2,6-TANA, ODA and HFBAPP) was added into the reaction bottle. The result was let to react at 200° C.-220° C. for 6 hours, obtaining Film composition (7) employing the polyimide of the disclosure, wherein Film composition (7) had a solid content about 25 wt %, and the solvent was dimethylacetamide.

Next, Film composition (7) was coated on a substrate (such as glass substrate) by blade coating, forming a coating (with a thickness of about 18 μm). Next, after baking the coating at 80° C. for 30 minutes, the solvent (DMAC) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Example 6

Example 6 was performed in the same manner as in Example 5, except that 4,4′-oxydianiline (ODA) was increased from 40 parts by mole to 50 parts by mole, and 2,2-bis[4-(4-aminophenoxy)phenyl]hexafluoropropane (HFBAPP) was reduced from 60 parts by mole to 50 parts by mole, obtaining Film composition (8) employing the polyimide of the disclosure, wherein Film composition (8) had a solid content about 25 wt %, and the solvent was 1-methyl-2-pyrrolidinone.

Next, Film composition (8) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Example 7

### 2,2-bis[4-(3,4-dicarboxyphenoxy)phenyl]propanedianhydride (BPADA)

(80 parts by mole), p-phenylenebis (trimellitate anhydride) (TAHQ) (20 parts by mole), 4,4′-oxydianiline (ODA) (40 parts by mole) and 1,3-bis(3-aminophenoxy) benzene (APB-N) (60 parts by mole) were added into a reaction bottle and dissolved in dimethylacetamide (DMAC), obtaining a solution (with a solid content of about 25 wt %). Next, isoquinoline (served as catalyst, with an amount of about 0.3 wt %,based on the total weight of BPADA, TAHQ, ODA and APB-N) was added into the reaction bottle. The result was let to react at 200° C.-220° C. for 6 hours, obtaining Film composition (9) employing the polyimide of the disclosure, wherein Film composition (9) had a solid content about 25 wt %, and the solvent was dimethylacetamide.

Next, Film composition (9) was coated on a substrate (such as glass substrate) by blade coating, forming a coating (with a thickness of about 18 μm). Next, after baking the coating at 80° C. for 30 minutes, the solvent (DMAC) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Example 8

### 2,2-bis[4-(3,4-dicarboxyphenoxy)phenyl]propanedianhydride (BPADA)

(70 parts by mole), p-phenylenebis (trimellitate anhydride) (TAHQ) (30 parts by mole), 4,4′-oxydianiline (ODA) (40 parts by mole) and 2,2-bis[4-(4-aminophenoxy)phenyl]hexafluoropropane (HFBAPP) (60 parts by mole) were added into a reaction bottle and dissolved in dimethylacetamide (DMAC), obtaining a solution (with a solid content of about 25 wt %). Next, isoquinoline (served as catalyst, with an amount of about 0.3 wt %, based on the total weight of BPADA, TAHQ, ODA and HFBAPP) was added into the reaction bottle. The result was let to react at 200° C.-220° C. for 6 hours, obtaining Film composition (10) employing the polyimide of the disclosure, wherein Film composition (10) had a solid content about 25 wt %, and the solvent was dimethylacetamide.

Next, Film composition (10) was coated on a substrate (such as glass substrate) by blade coating, forming a coating (with a thickness of about 18 μm). Next, after baking the coating at 80° C. for 30 minutes, the solvent (DMAC) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 3.

### Comparative Example 3

Comparative Example 3 Example 8 was performed in the same manner as in, except that 2,2-bis[4-(3,4-dicarboxyphenoxy)phenyl]propanedianhydride (BPADA) was reduced from 70 parts by mole to 10 parts by mole, and p-phenylenebis (trimellitate anhydride) (TAHQ) was increased from 30 parts by mole to 90 parts by mole, obtaining Film composition (11) employing the polyimide of the disclosure, wherein Film composition (11) had a solid content about 25 wt %, and the solvent was 1-methyl-2-pyrrolidinone.

Next, Film composition (11) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, and it was observed that no film could be prepared from the film composition or the film prepared from the film composition was easily broken.

TABLE 3

| | | | | | | | | water |
|---|---|---|---|---|---|---|---|---|
| | BPADA | 2,6-TANA | ODA | APB-N | HFBAPP | | | absorption |
| | (parts | (parts | (parts | (parts | (parts | Dk@ | Df@ | rate |
| | by mole) | by mole) | by mole) | by mole) | by mole) | 10 GHz | 10 GHz | (%) |
| Example 3 | 60 | 40 | 40 | 60 | — | 2.879 | 0.0028 | 0.39 |
| Example 4 | 70 | 30 | 40 | 60 | | 2.845 | 0.0045 | 0.58 |
| Example 5 | 60 | 40 | 40 | — | 60 | 2.720 | 0.0044 | 0.54 |
| Example 6 | 60 | 40 | 50 | — | 50 | 2.597 | 0.0043 | 0.46 |

| | | | | | | | | water |
|---|---|---|---|---|---|---|---|---|
| | BPADA | TAHQ | ODA | APB-N | HFBAPP | | | absorption |
| | (parts | (parts | (parts | (parts | (parts | Dk@ | Df@ | rate |
| | by mole) | by mole) | by mole) | by mole) | by mole) | 10 GHz | 10 GHz | (%) |
| Example 7 | 80 | 20 | 40 | 60 | — | 2.339 | 0.0040 | 0.44 |
| Example 8 | 70 | 30 | 40 | — | 60 | 2.861 | 0.0049 | 0.49 |

| | | | | | | |
|---|---|---|---|---|---|---|
| Comparative | 10 | 90 | 40 | — | 60 | No film formed |
| Example 3 | | | | | | |

As shown in Table 3 and Examples 3 and 4, when the molar ratio of BPADA and 2,6-TANA to ODA and APB-N is in the specific range for preparing the polyimide, the water absorption rate of the cured product of the obtained film composition can be reduced (for example the water absorption rate can be less than 0.6%), on the premise that the dielectric coefficient (Dk) and the dielectric loss factor are not increased. As shown in Examples 5 and 6, when the molar ratio of BPADA and 2,6-TANA to ODA and HFBAPP is in the specific range for preparing the polyimide, the water absorption rate of the cured product of the obtained film composition can be reduced (for example the water absorption rate can be less than 0.6%), on the premise that the dielectric coefficient (Dk) and the dielectric loss factor are not increased. As shown in Examples 7 and 8, when substituting TAHQ for 2,6-TANA and maintaining the specific molar ratio of BPADA to TAHQ, the water absorption rate of the cured product of the obtained film composition can be reduced (for example the water absorption rate can be less than 0.6%), on the premise that the dielectric coefficient (Dk) and the dielectric loss factor are not increased. In Comparative Example 3, since the molar ratio of BPADA to TAHQ was 1:9, Film composition (11) of Comparative Example 3 was not suitable for film coating.

### Example 9

### 2,2-bis[4-(3,4-dicarboxyphenoxy)phenyl]propanedianhydride (BPADA)

(60 parts by mole), 2,6-dihydroxynaphthalene bis(trimellitate anhydride) (2,6-TANA) (40 parts by mole), 2,2-bis[4-(4-aminophenoxy)phenyl]hexafluoropropane (HFBAPP) (40 parts by mole), and 1,3-bis(3-aminophenoxy) benzene (APB-N) (60 parts by mole) were added into a reaction bottle and then dissolved in N-methylpyrrolidinone (NMP), obtaining a solution (with a solid content of about 25 wt %). Next, isoquinoline (served as catalyst, with an amount of about 0.3 wt %, based on the total weight of BPADA, 2,6-TANA, HFBAPP and APB-N) was added into the reaction bottle. The result was let to react at 200° C.-220° C. for 6 hours, obtaining Film composition (12) employing the polyimide of the disclosure, wherein Film composition (12) had a solid content about 25 wt %, and the solvent was 1-methyl-2-pyrrolidinone.

Next, Film composition (12) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 4.

### Example 10

### 2,2-bis[4-(3,4-dicarboxyphenoxy)phenyl]propanedianhydride (BPADA)

(70 parts by mole), p-phenylenebis (trimellitate anhydride) (TAHQ) (30 parts by mole), 2,2-bis[4-(4-aminophenoxy)phenyl]hexafluoropropane (HFBAPP) (60 parts by mole), and 1,3-bis(3-aminophenoxy) benzene (APB-N) (40 parts by mole) were added into a reaction bottle and then dissolved in N-methylpyrrolidinone (NMP), obtaining a solution (with a solid content of about 25 wt %). Next, isoquinoline (served as catalyst, with an amount of about 0.3 wt %, based on the total weight of BPADA, TAHQ, HFBAPP and APB-N) was added into the reaction bottle. The result was let to react at 200° C.-220° C. for 6 hours, obtaining Film composition (13) employing the polyimide of the disclosure, wherein Film composition (13) had a solid content about 25 wt %, and the solvent was N-methylpyrrolidinone.

Next, Film composition (13) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 4.

### Example 11

Example 11 was performed in the same manner as in Example 10, except that 2,2-bis[4-(3,4-dicarboxyphenoxy)phenyl]propanedianhydride (BPADA) was increased from 70 parts by mole to 75 parts by mole, and p-phenylenebis (trimellitate anhydride) (TAHQ) was reduced from 30 parts by mole to 25 parts by mole, obtaining Film composition (14) employing the polyimide of the disclosure, wherein Film composition (14) had a solid content about 25 wt %, and the solvent was N-methylpyrrolidinone.

Next, Film composition (14) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 4.

### Example 12

Example 12 was performed in the same manner as in Example 10, except that 2,2-bis[4-(3,4-dicarboxyphenoxy)phenyl]propanedianhydride (BPADA) was increased from 70 parts by mole to 80 parts by mole, and p-phenylenebis (trimellitate anhydride) (TAHQ) was reduced from 30 parts by mole to 20 parts by mole, obtaining Film composition (15) employing the polyimide of the disclosure, wherein Film composition (15) had a solid content about 25 wt %, and the solvent was N-methylpyrrolidinone.

Next, Film composition (15) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 4.

### Comparative Example 4

Comparative Example 4 was performed in the same manner as in Example 12, except that 2,2-bis[4-(3,4-dicarboxyphenoxy)phenyl]propanedianhydride (BPADA) was reduced from 80 parts by mole to 10 parts by mole, and p-phenylenebis (trimellitate anhydride) (TAHQ) was increased from 20 parts by mole to 90 parts by mole, obtaining Film composition (16) employing the polyimide of the disclosure, wherein Film composition (16) had a solid content about 25 wt %, and the solvent was N-methylpyrrolidinone.

Next, Film composition (16) was coated on a substrate (such as glass substrate) by blade coating, forming a coating (with a thickness of about 18 μm). Next, after baking the coating at 80° C. for 30 minutes, the solvent (NMP) was removed. Next, the substrate with the coating was baked at 150° C. under nitrogen atmosphere for 30 minutes and then baked at 220° C. for 60 minutes, and it was observed that no film could be prepared from the film composition or the film prepared from the film composition was easily broken.

TABLE 4

| | | | | | | | water |
|---|---|---|---|---|---|---|---|
| | BPADA | 2,6-TANA | APB-N | HFBAPP | | | absorption |
| | (parts | (parts | (parts | (parts | Dk@ | Df@ | rate |
| | by mole) | by mole) | by mole) | by mole) | 10 GHz | 10 GHz | (%) |
| Example 9 | 60 | 40 | 60 | 40 | 2.515 | 0.0043 | 0.22 |

| | | | | | | | water |
|---|---|---|---|---|---|---|---|
| | BPADA | TAHQ | APB-N | HFBAPP | | | absorption |
| | (parts | (parts | (parts | (parts | Dk@ | Df@ | rate |
| | by mole) | by mole) | by mole) | by mole) | 10 GHz | 10 GHz | (%) |
| Example 10 | 70 | 30 | 40 | 60 | 2.372 | 0.0040 | 0.41 |
| Example 11 | 75 | 25 | 40 | 60 | 2.338 | 0.0042 | 0.39 |
| Example 12 | 80 | 20 | 40 | 60 | 2.577 | 0.0024 | 0.48 |

| | | | | | |
|---|---|---|---|---|---|
| Comparative | 10 | 90 | 40 | 60 | No film formed |
| Example 4 | | | | | |

As shown in Table 4 and Examples 9 -12, when the molar ratio of the first dianhydride (such as BPADA) to the first diamine (such as APB-N) and the second diamine (such as HFBAPP) is in the specific range for preparing the polyimide, the water absorption rate of the cured product of the obtained film composition can be reduced, on the premise that the dielectric coefficient (Dk) and the dielectric loss factor are not increased As shown in Comparative Example 4, when the ratio of the first dianhydride and second dianhydride is not within the specific range defined by the disclosure, the obtained film composition was not suitable to be used for film forming or the cured product prepared therefrom exhibits poor dielectric coefficient, dielectric loss factor, and has relatively high water absorption rate.

### Example 13

### 2,2-bis[4-(3,4-dicarboxyphenoxy)phenyl]propanedianhydride (BPADA)

(75 parts by mole), p-phenylenebis (trimellitate anhydride) (TAHQ) (25 parts by mole), 4,4′-Oxybis[3-(trifluoroMethyl)aniline] (TMDA) (40 parts by mole), 2,2-bis [4-(4-aminophenoxy)phenyl] propane (BAPP) (50 parts by mole), and bis(4-aminophenyl) terephthalate (BPTP) (bis(4-aminophenyl) terephthalate), BPTP) (10 parts by mole) was added into a reaction bottle and dissolved in γ-butyrolactone (GBL), obtaining a solution (with a solid content of about 25 wt %). Next, isoquinoline (served as catalyst, with an amount of about 0.3 wt %, based on the total weight of BPADA, TAHQ, TMDA, BAPP and BPTP) was added into the reaction bottle. The result was let to react at 200° C.-220° C. for 6 hours, obtaining Film composition (17) employing the polyimide of the disclosure, wherein Film composition (17) had a solid content about 25 wt %, and the solvent was γ-butyrolactone.

Next, Film composition (17) was coated on a substrate (such as glass substrate) by blade coating, forming a coating (with a thickness of about 18 μm). Next, after baking the coating at 80° C. for 30 minutes, the solvent (GBL) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 5.

### Example 14

Example 14 was performed in the same manner as in Example 13, except that 2,2-bis[4-(3,4-dicarboxyphenoxy)phenyl]propanedianhydride (BPADA) was increased from 75 parts by mole to 80 parts by mole, and p-phenylenebis (trimellitate anhydride) (TAHQ) was reduced from 25 parts by mole to 20 parts by mole, obtaining Film composition (18) employing the polyimide of the disclosure, wherein Film composition (18) had a solid content about 25 wt %, and the solvent was γ-butyrolactone.

Next, Film composition (18) was coated on a substrate (such as glass substrate) by blade coating, forming a coating (with a thickness of about 18 μm). Next, after baking the coating at 80° C. for 30 minutes, the solvent (GBL) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 5.

### Comparative Example 5

Comparative Example 5was performed in the same manner as in Example 13, except that 2,2-bis[4-(3,4-dicarboxyphenoxy)phenyl]propanedianhydride (BPADA) was increased from 75 parts by mole to 90 parts by mole, and p-phenylenebis (trimellitate anhydride) (TAHQ) was reduced from 25 parts by mole to 10 parts by mole, obtaining Film composition (19) employing the polyimide of the disclosure, wherein Film composition (19) had a solid content about 25 wt %, and the solvent was γ-butyrolactone.

Next, Film composition (19) was coated on a substrate (such as glass substrate) by blade coating, forming a coating (with a thickness of about 18 μm). Next, after baking the coating at 80° C. for 30 minutes, the solvent (GBL) was removed. Next, the substrate with the coating was baked at 150° C. under nitrogen atmosphere for 30 minutes and then baked at 220° C. for 60 minutes, obtaining a cured product. Finally, the dielectric coefficient (Dk), dielectric loss factor (Df), and water absorption rate of the cured product were measured, the results are shown in Table 5.

### Comparative Example 6

Comparative Example 6 was performed in the same manner as in Example 13, except that 2,2-bis[4-(3,4-dicarboxyphenoxy)phenyl]propanedianhydride (BPADA) was reduced from 75 parts by mole to 20 parts by mole, and p-phenylenebis (trimellitate anhydride) (TAHQ) was increased from 25 parts by mole to 80 parts by mole, obtaining Film composition (20) employing the polyimide of the disclosure, wherein Film composition (20) had a solid content about 25 wt %, and the solvent was γ-butyrolactone.

Next, Film composition (20) was coated on a substrate (such as glass substrate) by blade coating, forming a coating (with a thickness of about 18 μm). Next, after baking the coating at 80° C. for 30 minutes, the solvent (GBL) was removed. Next, the substrate with the coating was baked at 150° C. under nitrogen atmosphere for 30 minutes and then baked at 220° C. for 60 minutes, and it was observed that no film could be prepared from the film composition or the film prepared from the film composition was easily broken.

TABLE 5

| | | | | | | | | water |
|---|---|---|---|---|---|---|---|---|
| | BPADA | TAHQ | TMDA | BAPP | BPTP | | | absorption |
| | (parts | (parts | (parts | (parts | (parts | Dk@ | Df@ | rate |
| | by mole) | by mole) | by mole) | by mole) | by mole) | 10 GHz | 10 GHz | (%) |
| Example 13 | 75 | 25 | 40 | 50 | 10 | 2.472 | 0.0050 | 0.30 |
| Example 14 | 80 | 20 | 40 | 50 | 10 | 2.338 | 0.0033 | 0.29 |
| Comparative | 90 | 10 | 40 | 50 | 10 | 2.895 | 0.0072 | 1.33 |
| Example 5 | | | | | | | | |

| | | | | | | |
|---|---|---|---|---|---|---|
| Comparative | 20 | 80 | 40 | 50 | 10 | failed to form a film |
| Example 6 | | | | | | |

As shown in Table 5 and Examples 13 and 14, since the polyimide of the disclosure is prepared by reacting the specific dianhydride with the specific diamine at the specific molar ratio, the water absorption rate of the cured product of the obtained film composition can be reduced (for example the water absorption rate can be not greater than 0.3%), on the premise that the dielectric coefficient (Dk) and the dielectric loss factor are not increased. As shown in Comparative Examples 5 and 6, when the ratio of the first dianhydride and second dianhydride is not within the specific range defined by the disclosure, the obtained film composition was not suitable for film coating or the cured product prepared therefrom exhibits poor dielectric coefficient, dielectric loss factor (such as higher than 0.0050), and has relatively high water absorption rate (such as greater than 1%).

Accordingly, the cured product of the film composition of the disclosure (including the polyimide of the disclosure) exhibits low dielectric coefficient (Dk) and low dielectric loss factor (Df) at high frequency (such as larger than 10 GHz) and has a low water absorption rate. Therefore, the film prepared from the film composition of the disclosure can have stable dielectric characteristics.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A polyimide, which is a reaction product of a reactant (a) and a reactant (b), wherein the reactant (a) consists of a first dianhydride and a second dianhydride, the first dianhydride has a structure represented by Formula (I), and the second dianhydride has a structure represented by Formula (II) 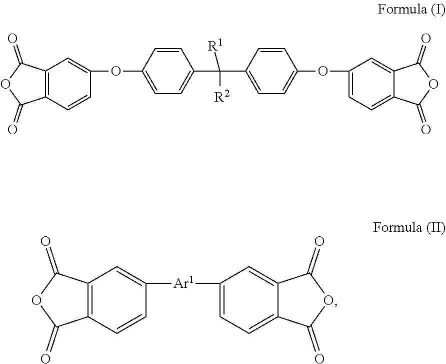
wherein R¹ and R² are independently hydrogen, fluorine, methyl group, ethyl group, propyl group, fluoromethyl group, fluoroethyl group, or fluoropropyl group; Ar¹ is 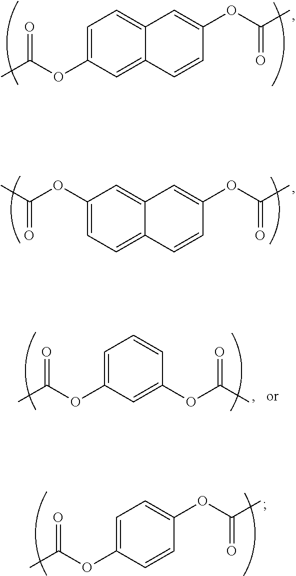
and reactant (b) comprises a first diamine, wherein the first diamine is 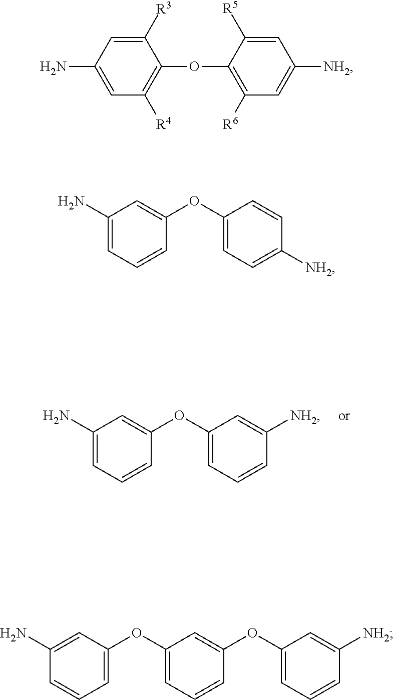
and R³, R⁴, R⁵, or R⁶ are independently hydrogen, fluorine, methyl group, ethyl group, propyl group, fluoromethyl group, fluoroethyl group, or fluoropropyl group.

2. The polyimide as claimed in claim 1, wherein the molar ratio of the first dianhydride to the second dianhydride is 3:7 to 8:2.

3. The polyimide as claimed in claim 1, wherein the reactant (b) further comprises a second diamine, wherein the second diamine is 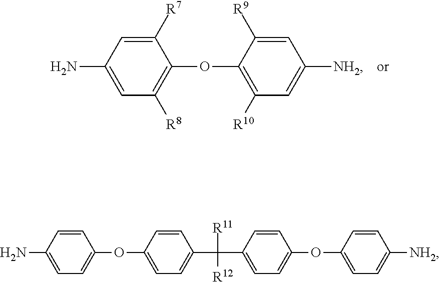
wherein R7, R8, R9, R10, R11, or R12 are independently hydrogen, fluorine, methyl group, ethyl group, propyl group, fluoromethyl group, fluoroethyl group, or fluoropropyl group, and the first diamine is different from the second diamine.

4. The polyimide as claimed in claim 3, wherein the molar ratio of the first diamine to the second diamine is 1:9 to 9:1.

5. The polyimide as claimed in claim 3, wherein the reactant (b) further comprises a third diamine, wherein the third diamine is

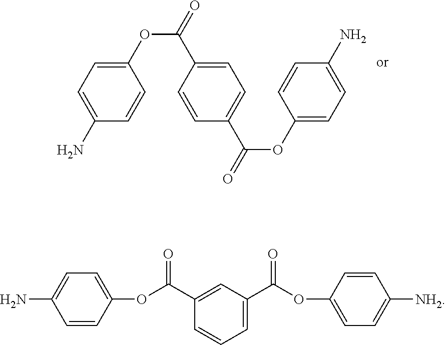 [SMILES: Nc1ccc(OC(=O)c2ccc(C(=O)Oc3ccc(N)cc3)cc2)cc1 ; Nc1ccc(OC(=O)c2cccc(C(=O)Oc3ccc(N)cc3)c2)cc1]

6. The polyimide as claimed in claim 5, wherein the molar ratio of the third diamine to the first diamine and the second diamine is 1:99 to 1:9.

7. The polyimide as claimed in claim 1, wherein the polyimide has a weight average molecular weight of 5,000 g/mol to 3,000,000 g/mol.

8. A film composition, comprising:
the polyimide as claimed in claim 1; and
a solvent, wherein the film composition has a solid content of 5 wt % to 30 wt %.

9. The film composition as claimed in claim 8, wherein the solvent is N-methylpyrrolidinone, dimethylacetamide, γ-butyrolactone, or p-xylene.

10. A film, which is a cured product of the film composition as claimed in claim 8.
